(19) United States
(12) Patent Application Publication
(10) Pub. No.: US 2007/0131356 A1
(43) Pub. Date: Jun. 14, 2007

(54) Applicator and tube dispenser for low and high viscosity adhesive components

(75) Inventor: Peter Battisti, Alpharetta, GA (US)

Correspondence Address: LEACH PATENT SERVICES, 5 EAST ALDINE DRIVE, HOCKESSIN, DE, 19707, US

(73) Assignee: Clast Trading LTD, Hong Kong (HK)

(21) Appl. No.: 11/298,376

(22) Filed: Dec. 9, 2005

(51) Int. Cl. B65C 11/04

(52) U.S. Cl. 156/578

(57) ABSTRACT

Disclosed are a sponge applicator device, and a tube dispenser for adhesive compositions and adhesive components which comprise a sponge applicator device. The tube includes an upper neck body which is cylindrical with exterior threads so that the sponge applicator cap may be attached. The sponge applicator comprises a rigid cap portion having interior threads, a cylindrical top end having a longitudinal channel, an absorbent, porous applicator material covering the external opening of said longitudinal channel, and a lance centered within the said threaded cap and coaxial with said longitudinal channel. The porous applicator material may be affixed to the end of the top end with an adhesive, or held in place by a snap ring.

In one embodiment of the invention, a tube dispenser for low and high viscosity adhesives or adhesive components comprises a tube dispenser as shown in FIG. 2, having a main tubular body, 21, an upper neck portion extending inwardly from the upper end of the main tubular body portion, 22,.wherein the upper neck portion comprises a spiral exterior thread, 23. The upper end of the neck portion is sealed to contain the low and high viscosity adhesive components, and to prevent the intrusion of moisture or other contaminants which would contaminate or initiate premature polymerization of the cyanoacrylate adhesive composition. The lower end portion of the tube dispenser can be sealed with a flat horizontal seal, 24. The tube should have at least one portion which is squeezable with mild to moderate pressure, so that the contents of the tube may be easily dispensed through the applicator when the seal of the tube is opened. FIG. 3 illustrates another longitudinal view of a tube dispenser, rotated 90° from FIG. 2. In another embodiment of the invention, the lower end portion of a tube dispenser is closed with a flat bottom, 41, as illustrated in FIG. 4. The tube may be made of any material commonly used to make tubes as described herein. Commonly used materials include aluminum or aluminum alloys. Other tube dispensers which contain a material to be delivered, and are sealed with a pierce able seal could be used with the sponge applicator cap.

The adhesives, or adhesive components, can be applied from the tube dispenser with a sponge applicator. In one embodiment of the invention illustrated in FIG. 1, the sponge applicator comprises a rigid cap portion, 11, having interior threads, 12, a cylindrical top end, 13, having a longitudinal channel, 14, an absorbent porous applicator material, 15, covering the external opening of the longitudinal channel, and a lance, 16, centered within the threaded cap and coaxial with the longitudinal channel, 14. The absorbent porous applicator material may be any absorbent material that allows passage of the adhesive. Exemplary absorbent materials include without limitation, an open cell form, cloth, cotton wool, or mesh. Upon attaching the sponge applicator to the tube reservoir, as the applicator cap is screwed onto the threads of the tube, the lance is pressed against the seal, and pierces the seal to open the tube. Upon compression or squeezing of the tube, the contents flow through the longitudinal channel, 14, and into the absorbent porous applicator material, 15, from where they can be applied to a desired area through any appropriate method, including dabbing, or a swabbing motion.

In another embodiment of the invention, the rigid cap portion may further comprise longitudinal ridges, 51, disposed on the exterior of the rigid cap portion as illustrated in FIGS. 5 and 6, to facilitate holding the cap portion when screwing it onto the tube dispenser in preparation to apply the adhesive or adhesive components. The rigid cap portion may also comprise a cylindrical flange, 52, extending upward coaxially from the rigid cap portion as illustrated in FIGS. 5 and 7.

In yet another embodiment of the invention, the rigid cap portion further comprises a circumferential groove, 81, as illustrated in FIG. 8.

In some embodiments of the invention, the absorbent porous applicator material, 15, of FIG. 1 is affixed to the said cylindrical top end with an adhesive. Any particular kind of adhesive which would provide adhesion of the absorbent porous applicator material to the cylindrical top would be appropriate, including hot melt adhesives, air curable adhesives, or thermosetting adhesives would suffice. In other embodiments of the invention, the absorbent applicator material is held in place enclosing the cylindrical top end of the cap by a snap ring illustrated in FIGS. 10, 11 and 12. In some embodiments, the snap ring further comprises a cylindrical flange, 122, extending upward coaxially as illustrated in FIG. 12.

FIG. 11 illustrates one embodiment of the snap ring wherein the means for securing the absorbent porous applicator is a series of teeth, 111, arrayed around the interior circumference, 112, of the snap ring. In another embodiment of the snap ring, the means for securing the absorbent porous applicator is a flange, 131, disposed around the interior circumference of the snap ring as illustrated in FIG. 13.

As illustrated in FIG. 12, the snap ring further comprises an inner circumferential ring, 121, disposed to engage the circumferential groove, 81, of the rigid cap portion of the sponge applicator.

FIG. 15 illustrates an embodiment of the sponge applicator having an inner circumferential ring, 151, engaging the circumferential groove, 154, of the cylindrical top end, and a flange 152 for securing the absorbent porous applicator, 153, wherein there is no cylindrical flange extending upward coaxially as in other embodiments.

In one embodiment of the invention, the adhesive to be dispensed and applied with the applicator is a cyanoacrylate composition comprising a cyanoacrylate monomer or monomers which can be selected from the group consisting of alkyl 2-cyanoacrylate, alkenyl 2-cyanoacrylate, alkoxyalkyl 2-cyanoacrylate, or carbalkoxyalkyl 2-cyanoacrylate. The alkyl group of the cyanoacrylate monomer or monomers preferably has 2 to 12 carbon atoms, and includes cycloalkyl functionality. Suitable cyanoacrylates include for example methyl 2-cyanoacrylate, ethyl 2-cyanoacrylate, n-propyl 2-cyanoacrylate, iso-propyl 2-cyanoacrylate, n-butyl 2-cyanoacrylate, iso-butyl 2-cyanoacrylate, hexyl 2-cyanoacrylate, n-octyl 2-cyanoacrylate, 2-octyl 2-cyanoacrylate, 2-methoxyethyl 2-cyanoacrylate, 2 -ethoxyethyl 2-cyanoacrylate and 2-propoxyethyl 2-cyanoacrylate. In some embodiments of the invention, the cyanoacrylate monomers include n-butyl 2-cyanoacrylate, n-octyl 2 -cyanoacrylate and mixtures thereof.

In another embodiment of the invention, the cyanoacrylate composition further comprises a thickener so as to increase the viscosity of the cyanoacrylate adhesive. Depending on the molecular weight of the thickening polymer, and the amount used, the viscosity of the adhesive composition can be anywhere from water-like, to almost paste-like. Suitable thickeners include polymers which are soluble in the cyanoacrylate monomer. Polymer compounds which may be used as a thickening agent include biologically suitable polymer compounds made from at least one cyanoacrylate monomer. As stated above, the cyanoacrylate family includes ethyl cyanoacrylate, n-propyl cyanoacrylate, isopropyl cyanoacrylate, n-butyl cyanoacrylate, isobutyl cyanoacrylate, n-amyl cyanoacrylate, isoamyl cyanoacrylate, hexylcyanoacrylate octylcyanoacrylate, decylcyanoacrylate, 3-acetoxypropyl cyanoacrylate, 2-methoxypropyl-cyanoacrylate, 3-chloropropyl cyanoacrylate, benzyl cyanoacrylate, phenyl cyanoacrylate, alkenyl cyanoacrylate, butyl-2-cyanoacrylate, alkoxyalkyl 2-cyanoacrylates, fluorinated 2-cyanoacrylates, and carbalkoxyalkyl cyanoacrylates, depending upon acceptable toxicity and other properties for a given application. Other members of the cyanoacrylate family may be suitable to form the cyanoacrylate polymer for use as a thickening agent. Examples of cyanoacrylate polymers having a longer chain R group are poly(octylcyanoacrylate) and poly(decylcyanoacrylate).

In another embodiment of the invention, the cyanoacrylate composition further comprises a plasticizer. Suitable plasticizers include but are not limited to, tributyl citrate, acetyl tributyl citrate, dimethyl sebacate, diethylsebacate, triethyl phosphate, tri(2-ethyl-hexyl) phosphate, tri(p- cresyl) phosphate, glyceryl triacetate, glyceryl tributyrate, dioctyl adipate, isopropyl myrisate, butyl sterate, lauric acid, trioctyl trimelliate, dioctyl glutatrate and mixtures thereof. In yet another embodiment of the invention, the plasticizer is tributyl citrate.

In another embodiment of the invention the cyanoacrylate compositions of the invention can be stabilized against premature polymerization with anionic and free-radical polymerization inhibitors. Anionic polymerization inhibitors, known in the art include soluble acidic gases (for example sulfur dioxide), and phosphoric, carboxylic and organic sulphonic acids. Free-radical polymerization inhibitors include hydroquinone, t-butyl catechol, hydroxyanisole, butylated hydroxyanisole and butylated hydroxytoluene. Preferred polymerization inhibitors include butylated hydroxyanisole, hydroxyanisole, butylated hydroxytoluene, and mixtures thereof.

### Brief Description of the Drawings

For a more complete understanding of the features and objects of the invention, reference should be made to the following detailed description of the invention and the accompanying drawings, in which:

FIG. 1 is a longitudinal cross section of the sponge applicator cap.

FIG. 2 is a longitudinal view of one embodiment of the tube dispenser.

FIG. 3 is another longitudinal view of one embodiment of the tube dispenser.

FIG. 4 is a longitudinal view of another embodiment of the tube dispenser.

FIG. 5 is a longitudinal view of one embodiment of the lower portion of the applicator cap having longitudinal ridges.

FIG. 6 is a cross sectional view of one embodiment of the lower portion of the applicator cap having longitudinal ridges.

FIG. 7 is a longitudinal cross section of another embodiment of the lower portion of the applicator cap.

FIG. 8 is a longitudinal view of another embodiment of the lower portion of the applicator cap having ridges, and a circumferential groove.

FIG. 9 is a longitudinal cross section of an embodiment without longitudinal ridges and having a circumferential groove.

FIG. 10 is a longitudinal view of one embodiment of a snap ring.

FIG. 11 is a top view of one embodiment of a snap ring illustrating teeth for securing the absorbent porous applicator material.

FIG. 12 is a longitudinal cross section of one embodiment of a snap ring illustrating teeth for securing the absorbent porous applicator material.

FIG. 13 is a longitudinal cross section of one embodiment of a sponge applicator assembly.

FIG. 14 is a longitudinal view of a sponge applicator assembly.

FIG. 15 is a longitudinal cross section of another embodiment of a sponge applicator assembly with a flange for securing the absorbent porous material and without an external cylindrical flange.

FIG. 16 is a longitudinal view of another embodiment of a sponge applicator assembly without an external cylindrical flange.

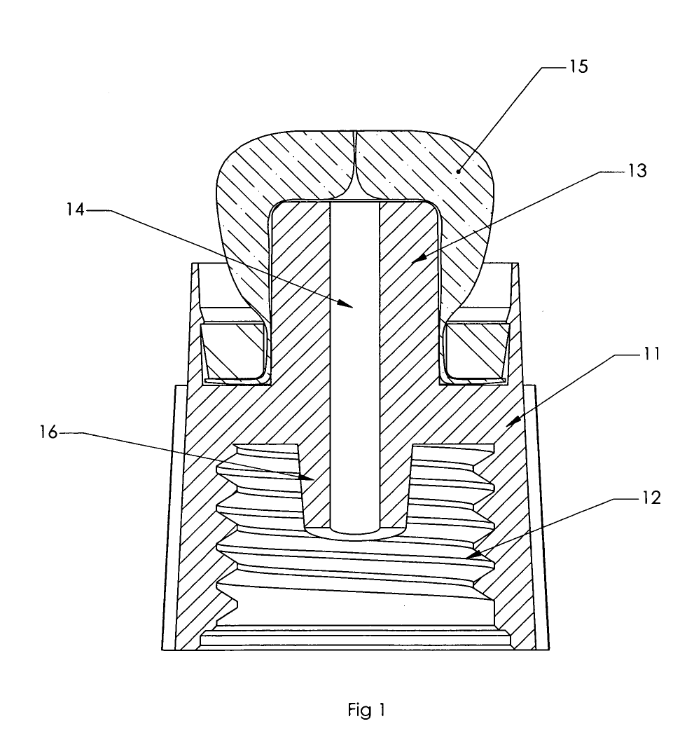

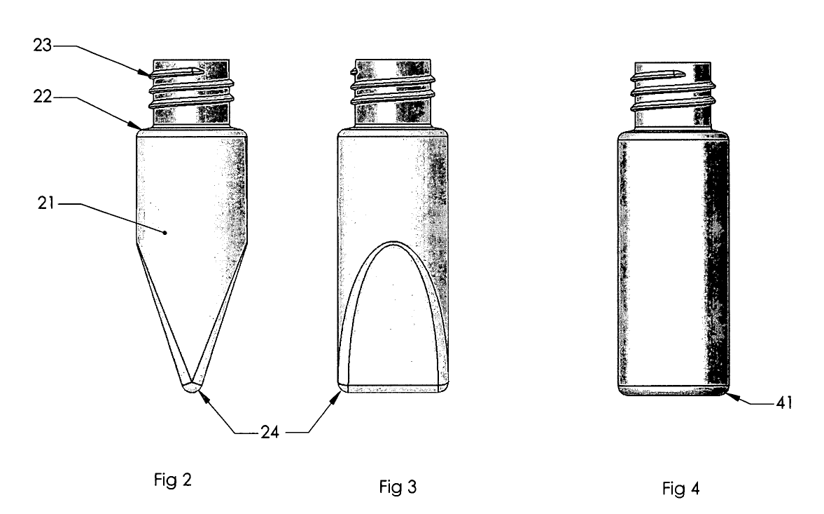

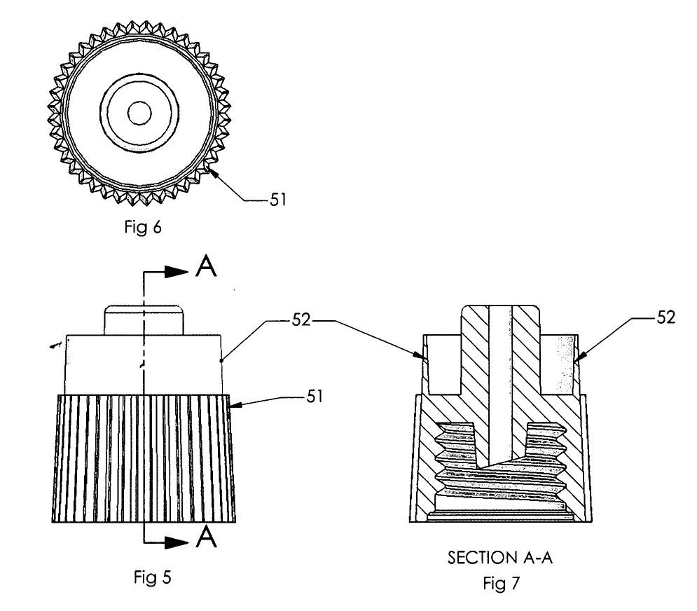

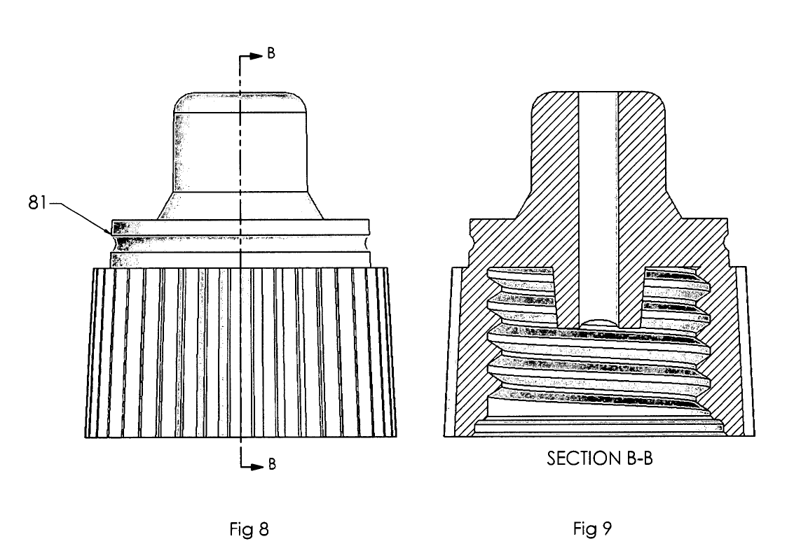

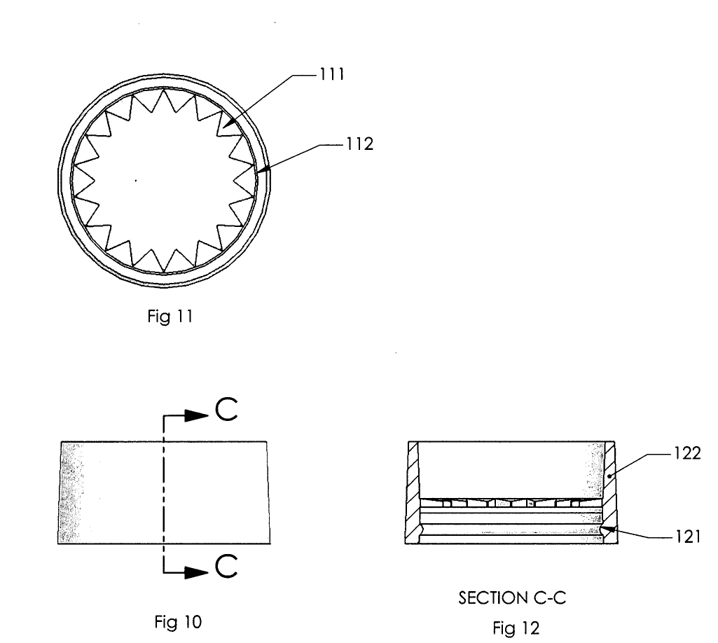

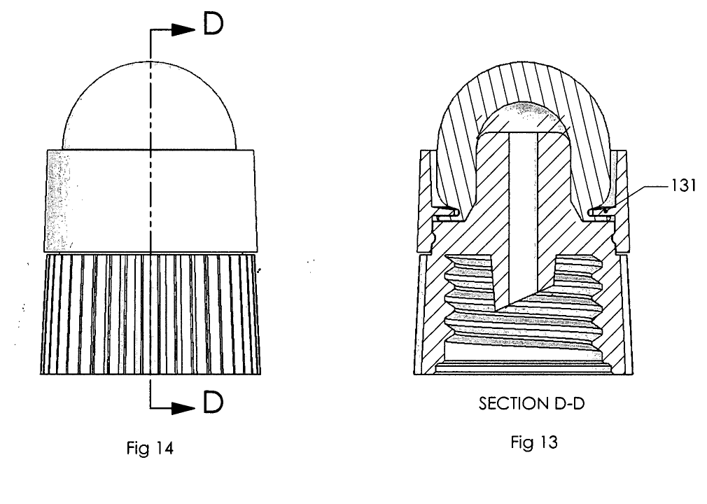

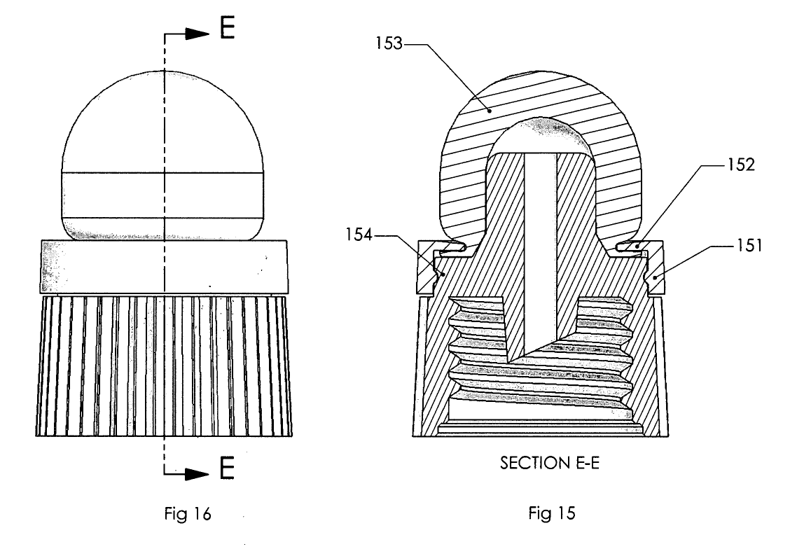

What is claimed is:

1. A sponge applicator top for a dispenser comprising:
a rigid cap portion having interior threads, a cylindrical top end having a longitudinal channel,
an absorbent, porous applicator material covering the external opening of said longitudinal channel, and
a lance centered within the said threaded cap and coaxial with said longitudinal channel.

2. A sponge applicator top as in claim 1 wherein the absorbent, porous applicator material encloses the cylindrical top end of the said sponge applicator.

3. A sponge applicator as in claim 2 wherein the absorbent, porous applicator material is attached to the cylindrical top end of the said sponge applicator with an adhesive.

4. A sponge applicator as in claim 2 wherein the rigid cap portion of the said sponge applicator further comprises a circumferential groove.

5. A sponge applicator as in claim 4 wherein the sponge applicator further comprises a snap ring comprising an inner circumferential ring, disposed to engage the said circumferential groove.

6. A sponge applicator as in claim 5 wherein the absorbent porous applicator material is held in place by said snap ring.

7. A sponge applicator as in claim 6 wherein the said absorbent porous applicator is held in place by said snap ring with an attachment means for securing the said absorbent porous applicator.

8. A sponge applicator as in claim 1 wherein the rigid cap portion of the sponge applicator further comprises adjacent longitudinal ridges disposed on the exterior of the cap.

9. A sponge applicator as in claim 1 wherein the rigid cap portion of the sponge applicator has a cylindrical flange extending upward from the cap, and coaxially with the cylindrical top end.

10. A tube dispenser for dispensing low or high viscosity adhesives or adhesive components comprising:
a tube dispenser having a main tubular body,
an upper neck portion extending inwardly from the upper end of the main tubular body portion, said upper neck portion comprising a spiral exterior thread, said upper neck portion being sealed, and the lower end of the tube dispenser being closed;
a sponge applicator for applying said cyanoacrylate for attachment around the upper neck portion, said sponge applicator comprising a rigid cap portion having interior threads,
a cylindrical top end having a longitudinal channel, an absorbent, porous applicator material covering the external opening of said longitudinal channel, and
a lance centered within the said threaded cap and coaxial with said longitudinal channel.

11. A tube dispenser as in claim 10 wherein the absorbent, porous applicator material encloses the cylindrical top end of the said sponge applicator.

12. A tube dispenser as in claim 11 wherein the absorbent, porous applicator material is attached to the cylindrical top end of the said sponge applicator with an adhesive.

13. A tube dispenser as in claim 11 wherein the rigid cap portion of the said sponge applicator further comprises a circumferential groove.

14. A tube dispenser as in claim 13 wherein the sponge applicator further comprises a snap ring comprising an inner circumferential ring, disposed to engage the said circumferential groove.

15. A tube dispenser as in claim 14 wherein the absorbent porous applicator material is held in place by said snap ring.

16. A tube dispenser as in claim 15 wherein the said absorbent porous applicator is held in place by said snap ring with an attachment means for securing the said absorbent porous applicator.

17. A tube dispenser as in claim 10 wherein the lower end of the main tubular body of the tube dispenser is sealed with a flat horizontal seal.

18. A tube dispenser as in claim 10 wherein the rigid cap portion of the sponge applicator further comprises adjacent longitudinal ridges disposed on the exterior of the cap.

19. A tube dispenser as in claim 10 wherein the rigid cap portion of the sponge applicator has a cylindrical flange extending upward from the cap, and coaxially with the cylindrical top end.

20. A tube dispenser as in claim 10 wherein the low or high viscosity adhesive or adhesive component is a cyanoacrylate adhesive composition.

21. A tube dispenser as in claim 20 wherein the cyanoacrylate adhesive comprises at least one cyanoacrylate monomer or monomers which can be selected from the group consisting of alkyl 2-cyanoacrylate, alkenyl 2-cyanoacrylate, alkoxyalkyl 2-cyanoacrylate, or carbalkoxyalkyl 2-cyanoacrylate.

22. A tube dispenser as in claim 21 wherein the alkyl group of the at least one alkyl 2-cyanoacrylate monomer is selected from the group consisting of C₂ to C₁₂ alkyl chains.

23. A tube dispenser as in claim 21 wherein the cyanoacrylate adhesive further comprises a thickener.

24. A tube dispenser as in claim 21 wherein the cyanoacrylate adhesive further comprises a plasticizer.

25. A tube dispenser as in claim 21 wherein the cyanoacrylate adhesive further comprises a stabilizer selected from the group consisting of free radical polymerization stabilizers and anionic polymerization stabilizers.

26. A tube dispenser as in claim 23 wherein the thickener is a polymer.
